(19) United States
(12) Patent Application Publication
(10) Pub. No.: US 2014/0352541 A1
(43) Pub. Date: Dec. 4, 2014

(54) CANISTER

(71) Applicant: MAHLE FILTER SYSTEMS JAPAN CORPORATION, Tokyo (JP)

(72) Inventors: Junpei Omichi, Kawagoe-shi (JP); Yuji Arase, Nerima-ku (JP); Takashi Hasumi, Nishitokyo-shi (JP)

(73) Assignee: MAHLE FILTER SYSTEMS JAPAN CORPORATION, Tokyo (JP)

(21) Appl. No.: 14/289,944

(22) Filed: May 29, 2014

(30) Foreign Application Priority Data
May 31, 2013 (JP) 2013-114897

(51) Int. Cl. F02M 25/08

(52) U.S. Cl. CPC F02M 25/0854; F02M 25/0872
USPC 96/152

(57) ABSTRACT

A canister includes: a casing charged with an adsorbing material; a charge port and a purge port disposed at one end of the casing; a drain port disposed at the other end of the casing; a flange section for defining an outer peripheral part of one end of an adsorbent chamber; a first cylindrical section projected from the flange section toward the adsorbent chamber and concentric with the casing; and a second cylindrical section extending from the flange section in the opposite direction and concentric with the casing. A space defined inside the first cylindrical section is provided to communicate with one of the charge port and the purge port, while a diffusion chamber communicates with the other of the charge port and the purge port. The flange section has orifices located adjacent to the first cylindrical section thereby communicating the adsorbent chamber and the diffusion chamber with each other.

### BACKGROUND OF THE INVENTION

This invention relates to improvements in a canister used in a vaporized fuel processing system for an automotive vehicle, and more particularly to a canister provided to have a cylindrically shaped casing in which longitudinal direction a gas is to flow.

As is well known, in an automotive vehicle using an engine, a vaporized fuel processing system having a canister as a main body is equipped in order to suppress a discharge of vaporized fuel within a fuel tank to the atmosphere.

The canister is filled with an adsorbent such as an activated carbon or so forth within a casing. While vaporized fuel generated within the fuel tank at a time of a vehicle stop is adsorbed onto the adsorbent, a fuel component is desorbed from the adsorbent by means of the atmosphere introduced through a drain port (also referred to as an atmosphere port) at a time of an engine operation and then sucked into an intake air system of the engine.

In the canister, if a charge port and a purge port are disposed simply adjacent to each other at a first end portion of a casing, charging of the vaporized fuel to the adsorbent is positively achieved on the side closer to the charge port (in a cross-sectional view perpendicular to the longitudinal direction of the casing) while purging of the fuel component from the adsorbent is positively achieved on the side closer to the purge port. In other words, charging and purging progress nonuniformly in any cross-sectional view, so that the adsorbent is not fully used in its entirety.

In view of this, there is disclosed in Patent Document 1 a canister locating a purge port at the center of a first end portion of a cylindrical casing while locating a charge port off the center (at an eccentric section). Between the charge port and the adsorbent, a slight clearance is provided all around the periphery of the charge port by the presence of an annular porous plate that surrounds the purge port.

Patent Document 1: Japanese Unexamined Utility Model Application Publication No. H05-021157

### SUMMARY OF THE INVENTION

However, drawbacks have been encountered in conventional canisters. In the construction of Patent Document 1 where the purge port is disposed at the center of the cylindrical casing, purging by means of the atmosphere introduced through a drain port located at a second end portion can generally uniformly progress at each section. However, charging is to progress more easily at locations closer to the charge port regardless of the presence of the slight clearance provided by the porous plate since the charge port is disposed at the eccentric section, which brings about a nonuniformity of the distribution of adsorption quantity in a circumferential direction in each cross-section. After all, the adsorbent is not fully used in its entirety even if purging can progress uniformly. In view of the above, an object of the present invention is to provide an improved canister which can effectively overcome drawbacks encountered in conventional canisters.

An aspect of the present invention is to provide a canister comprising: a cylindrical casing charged with an adsorbing material therein and having at one end and the other end of the longitudinal direction of the casing a first end portion and a second end portion, respectively; a charge port and a purge port both of which are disposed at the first end portion of the casing; a drain port disposed at the second end portion of the casing; an annularly shaped flange section disposed at the first end portion of the casing to define an outer peripheral part of one end of an adsorbent chamber; a first cylindrical section projected from the inner periphery of the flange section toward the side of the adsorbent chamber and concentric with the casing; and a second cylindrical section extending from the inner periphery of the flange section in the opposite direction of the first cylindrical section and concentric with the casing, wherein a space defined inside the first cylindrical section at the center of the casing communicates with a first port comprising either one of the charge port and the purge port, while a diffusion chamber circularly defined between the second cylindrical section and the casing communicates with a second port comprising the other one of the charge port and the purge port, and wherein the flange section has two or more orifices for communicating the adsorbent chamber and the diffusion chamber with each other, the orifices being located adjacent to the first cylindrical section and arranged concentrically about the first cylindrical section.

In the above-mentioned construction, either one of the charge port and the purge port is adapted to communicate with the space defined inside the first cylindrical section at the center of the casing, as the first port. With this, charging or purging is to progress in such a manner as to expand in radial direction all over the circumference thereby exhibiting a development uniform in circumferential direction. This means that charging and purging are surely performed all over the entire of the adsorbing material.

On the other hand, the second port comprising the other one of the charge port and the purge port is adapted to communicate with the diffusion chamber circularly defined outside the second cylindrical section, and additionally the diffusion chamber is provided to communicate with the adsorbent chamber side through the two or more orifices of the first cylindrical section. The two or more orifice are arranged concentrically about the first cylindrical section and adjacent to the first cylindrical section.

If the charge port is adapted to serve as the second port, a gas introduced from a fuel tank is gathered toward the axis of the casing (or near the outer peripheral surface of the second cylindrical section) in the diffusion chamber. Then, the gas is throttled by passing through each of the orifices so as to make a plurality of tiny flows, and thereafter flown along the outer peripheral surface of the first cylindrical section toward the side of the adsorbent chamber. In other words, the tiny flows of gas are delivered from and concentrically about an innermost location of an annular region defined by removing the space defined inside the first cylindrical section to communicate with the first port, toward the side of the adsorbent chamber. Accordingly, charging is to progress expansively in radial direction all over the circumference, so that the distribution of the adsorption quantity gets even in the circumferential direction. It is therefore possible to perform charging while making full use of the entire of the adsorbing material.

The same can be said of a case where the second port is the purge port. More specifically, purging is surely performed all over the entire of the adsorbing material since a purge gas is flown uniformly in the circumferential direction through the two or more orifices located radially near the center.

In an embodiment of the present invention, the first cylindrical section and the second cylindrical section are identical in outer diameter to each other and a screen member is disposed at the interface therebetween to define an end of the center of the adsorbent chamber. This means that the adsorbing material is substantially charged also into the interior of the first cylindrical section and charging or purging is performed therethrough.

In another embodiment of the present invention, the canister is provided to further include a third cylindrical section located inside an inner periphery of the second cylindrical section and smaller than the first cylindrical section in diameter, wherein the space defined inside the first cylindrical section communicates with the first port through a space defined inside the third cylindrical section. More specifically, the space defined inside the first cylindrical section is communicated at its center with the first port.

In a further embodiment of the present invention, the canister is provided to further includes a second diffusion chamber located between the diffusion chamber and the second port and adjacent to the diffusion chamber in the longitudinal direction of the casing, wherein the second diffusion chamber and the diffusion chamber are communicated with each other through two or more auxiliary throttling parts formed adjacent to an outer peripheral surface of the second cylindrical section. By the presence of the second diffusion chamber, the gas flow repeats two or more cycles of expansion and contraction, so that a biased flow in the circumferential direction is surely precluded regardless of the location of the second port connected.

It is preferable that the two or more orifices are arranged concentrically about the first cylindrical section at fixed intervals. However, some irregularities in the intervals caused by the intervention of the other member such as ribs may be acceptable so long as the distribution of the gas flow in the circumferential direction is substantially uniform.

According to the present invention, a gas flow is free from bias in the circumferential direction, and therefore charging and purging can progress uniformly in the circumferential direction when viewed in a cross-section perpendicular to the flow. Hence it is possible to make full use of the entire of the adsorbing material so as to improve the adsorption ability of the canister and additionally it is possible to prevent a leakage of fuel component due to an insufficient purging (the so-called bleed).

### BRIEF DESCRIPTION OF THE DRAWING

FIG. 1 is a longitudinal sectional view of an embodiment of a canister according to the present invention;

FIG. 2 is an enlarged longitudinal sectional view of a first end portion of the canister;

FIG. 3 is an enlarged exploded perspective view of the first end portion of the canister;

FIG. 4 is a transverse sectional view of the canister, taken along the line A-A of FIG. 1;

FIG. 5 is an enlarged longitudinal sectional view similar to FIG. 2, showing the flow of a charged gas and a purged gas; and

FIG. 6 is an enlarged exploded perspective view similar to FIG. 3, showing the flow of the charged gas and the purged gas.

### DETAILED DESCRIPTION OF THE INVENTION

Referring now to the accompanying drawings, an embodiment of the present invention will specifically be discussed.

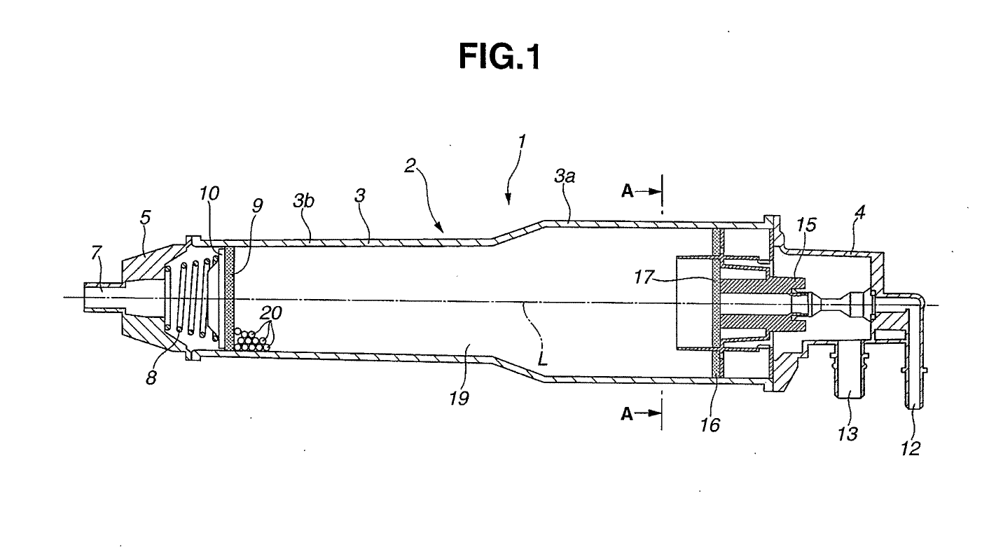

FIG. 1 is a longitudinal sectional view of an embodiment of a canister 1 according to the present invention. The canister 1 is provided to have a plastic casing 2. The casing 2 is comprised mainly of: a cylindrical main body 3 (a perfect circle in cross section) having a large-diameter part 3a and a small-diameter part 3b and having as its both ends a large-diameter part 3a side open end part and a small-diameter part 3b side open end part; a charge/purge side end cover 4 attached to the large-diameter part 3a side open end part of the main body 3; and a drain side end cover 5 attached to the small-diameter part 3b side open end part of the main body 3.

The drain side end cover 5 is formed having at its center a drain port 7 that extends along a center axis L of the main body 3. Additionally, the drain side end cover 5 holds a screen member 9 and a latticed plate 10 through a coil spring 8.

The charge/purge side end cover 4 is provided with: a purge port 12 having a center along the center axis L of the main body 3 and extending in a direction perpendicular thereto so as to be shaped like a letter L; and a charge port 13 connected to the end cover 4 from a radial direction. To one of the end pars of the main body 3, covered by the charge/purge side end cover 4, an integrally formed plastic bulkhead 15 is attached. The bulkhead 15 includes at its inner side an end surface on which screen members 16, 17 are disposed, which is to be discussed below more specifically. These screen members 16, 17 disposed at the end part of the main body 3 define the volume of an adsorbent chamber 19 together with the above-mentioned screen member 9 disposed on the side of the drain port 7.

The adsorbent chamber 19 is charged with granulated adsorbing material 20 made of activated carbon and the like, and maintained in a moderately biased or compressed condition by the spring 8.

Incidentally, it will be obvious to a person skilled in the art that the charge port 13 is provided to communicate with a fuel tank of a vehicle at an upper space inside the tank (not shown) while the purge port 12 is connected to an intake air system of an internal combustion engine (not shown). Furthermore, the drain port 7 is adapted to open to the atmosphere directly or indirectly through some device or pipe. For example, fuel vapors generated when the engine of the vehicle shuts off or during fuel feeding are introduced into the canister 1 through the charge port 13 and then linearly flown inside the main body 3 along the center axis L in the longitudinal direction, and adsorbed by the adsorbing material 20 during that time. The thus adsorbed fuel component is purged from the adsorbing material 20 by the air being drawn through the drain port 7 by a negative pressure generated in the intake air system during the running of the internal combustion engine, and then flown into the intake air system of the internal combustion engine through the purge port 12, and finally combusted in the internal combustion engine.

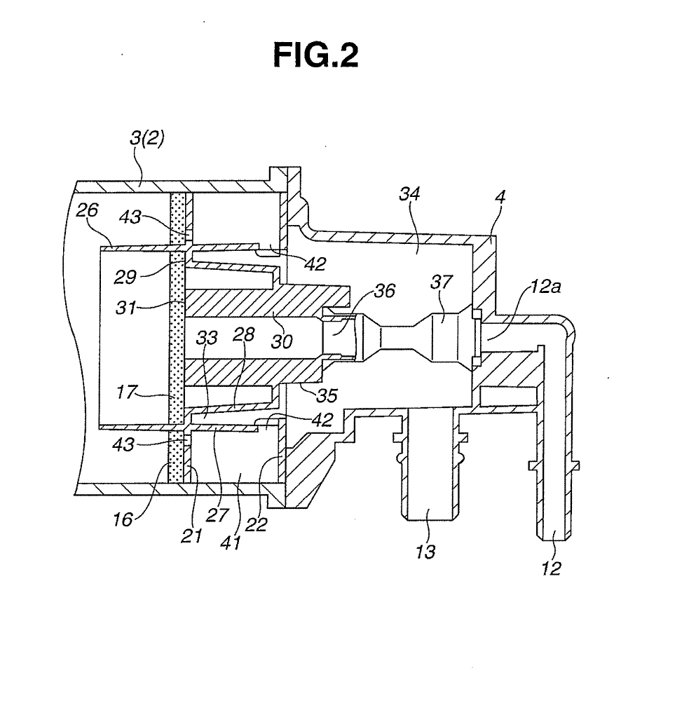

Referring now to FIGS. 2 to 4, the constructions of the charge/purge side end cover 4 and the bulkhead 15 will be discussed in detail.

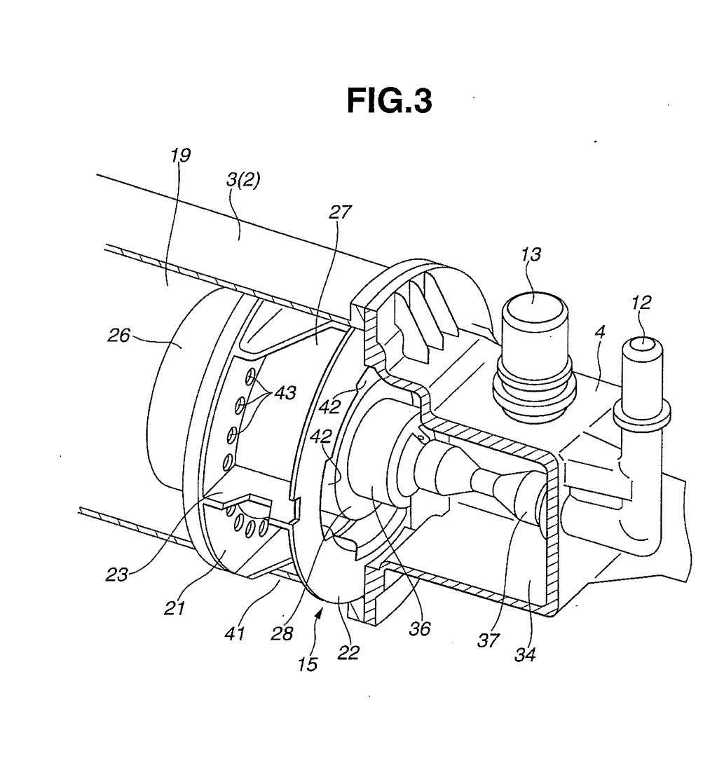

As shown in FIG. 3, the bulkhead 15 is provide with: an annularly shaped first flange section 21 defining one end of the adsorbent chamber 19; and an annularly shaped second flange section 22 to be positioned at the open end of the main body 3. These plate-like flange sections 21, 22 are connected to each other through a plurality of, radially arranged ribs 23. The first and second flange sections 21 and 22 are arranged in parallel with each other and disposed at some distance from each other in order to keep a necessary volume for a diffusion chamber 41 discussed below. The first flange section 21 has an inner peripheral edge at which a first cylindrical section 26 projecting from the first flange section 21 toward the side of the adsorbent chamber 19, and a second cylindrical section 27 extending opposite to the first cylindrical section 26 are connected. The first cylindrical section 26 and the second cylindrical section 27 are identical with each other in outer diameter and inner diameter and therefore substantially regarded as forming one cylinder; however, the first flange section 21 is formed to have an annular surface 29 (defined by the first flange section 21 annularly projecting to the inner peripheral side) and screen-supporting surfaces 31 (defined by end edges of ribs 30 arranged radially in the longitudinal direction of the first flange section 21) at the interface between the first cylindrical section 26 and the second cylindrical section 27 as shown in FIG. 2. The above-mentioned screen member 17 is supported on the screen-supporting surfaces 31. Incidentally, the screen member 16 annularly formed and located on the outer peripheral side is supported by the first flange section 21.

The second cylindrical section 27 is formed having on its inner peripheral side a third cylindrical section 28 coaxial therewith. The above-mentioned radially arranged ribs 30 are provided at the inner peripheral side of the third cylindrical section 28. Each of the first cylindrical section 26, the second cylindrical section 27 and the third cylindrical section 28 is disposed coaxial with the main body 3. Moreover, the third cylindrical section 28 is smaller than the first cylindrical section 26 and the second cylindrical section 27 in diameter. The third cylindrical section 28 and the second cylindrical section 27 define an annular space 33 therebetween as shown in FIG. 2. The annular space 33 opens into a space defined by the charge/purge side end cover 4 or into a charged gas chamber 34 corresponding to a second diffusion chamber.

Furthermore, the third cylindrical section 28 is formed to have an end wall portion on the side of the charged gas chamber 34, at which there is provided a cup-shaped fourth cylindrical section 35 smaller than the third cylindrical section 28 in diameter. An end wall portion of the fourth cylindrical section 35 (i.e. the above-mentioned end wall portion the third cylindrical section 28) is opened at its center so as to serve as a purge outlet 36.

More specifically, the third cylindrical section 28 and the fourth cylindrical section 35 disposed concentrically with each other are continuously shaped to establish a stepwise structure, in which the radially arranged ribs 30 are adapted to extend to the interior of the fourth cylindrical section 35. The purge outlet 36 is connected to an inlet portion 12a of the purge port 12 which inlet portion 12 a is located on the side of the charge/purge side end cover 4, through a connecting pipe 37 which is formed of other material and extends inside the charged gas chamber 34. Both of the inlet portion 12a and the connecting pipe 37 are disposed coaxial with the center axis L of the main body 3, so that a purged gas is to linearly flow along the center axis L into the inlet portion 12a by way of the center of the second cylindrical section 27. Incidentally, the connecting pipe 37 has a shape of an ejector reduced in diameter at its mid portion, and can function as an ejector pump for sucking up liquid fuel that remains on the bottom of the charged gas chamber 34; however, a detailed description thereof will be omitted since this is out of main points of the present invention.

Meanwhile, between an outer peripheral surface of the second cylindrical section 27 and an inner peripheral surface of the main body 3, an annular diffusion chamber 41 partitioned by the first flange section 21 and the second flange section 22 is defined. The second flange section 22 has an inner peripheral edge behaving as a connecting part through which the second cylindrical section 27 and the second flange section 22 are connected, and provided with apertures (or cutoffs) 42 arranged around and near the inner peripheral edge at two or more parts (for example, at three parts) for the diffusion chamber 41 and the charged gas chamber 34 communicating with each other. The apertures 42 can function as auxiliary throttling parts for reducing the flow of charged gas in the charged gas chamber 34 and gathering it toward the center so as to guide it into the diffusion chamber 41.

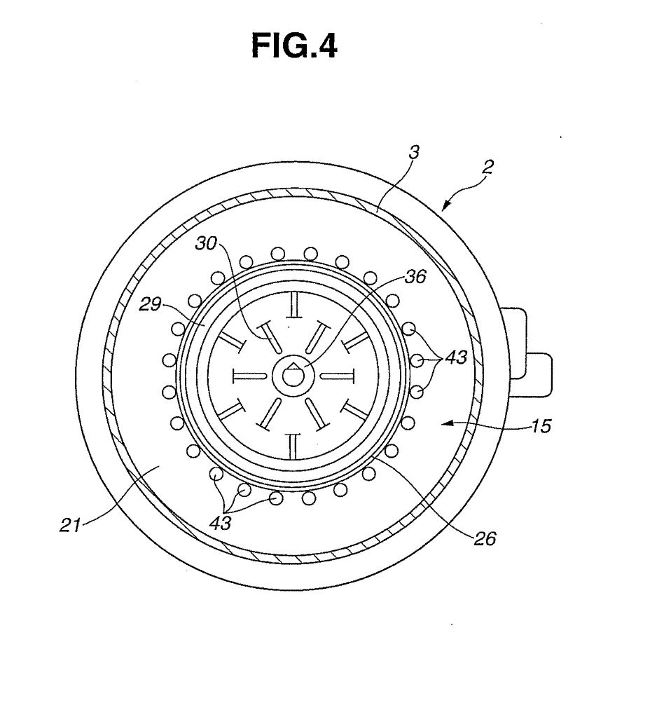

Furthermore, the annularly shaped first flange section 21 serving as a partition between the diffusion chamber 41 and the adsorbent chamber 19 is formed with many small circular orifices 43, as shown in FIGS. 3 and 4. The diffusion chamber 41 and the adsorbent chamber 19 can communicate with each other through the orifices 43. A plurality of orifices 43 are arranged concentrically with the first and second cylindrical sections 26 and 27 and the main body 3 at regular intervals, and more particularly, located possibly close to the outer peripheral surface of the second cylindrical section 27 and that of the first cylindrical section 26. As a concrete example, twenty four orifices 43 are arranged at fixed intervals. Incidentally, FIG. 4 shows orifices 43 and the like in a state where the screen members 16, 17 are taken away.

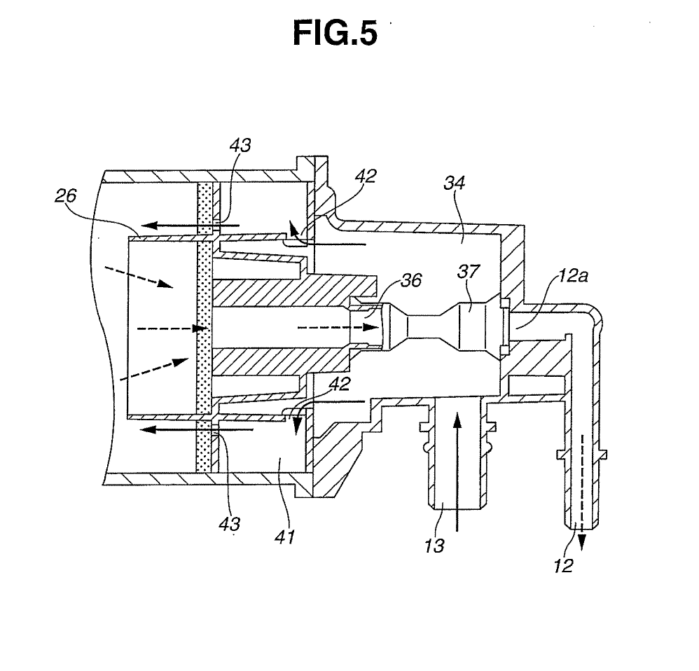

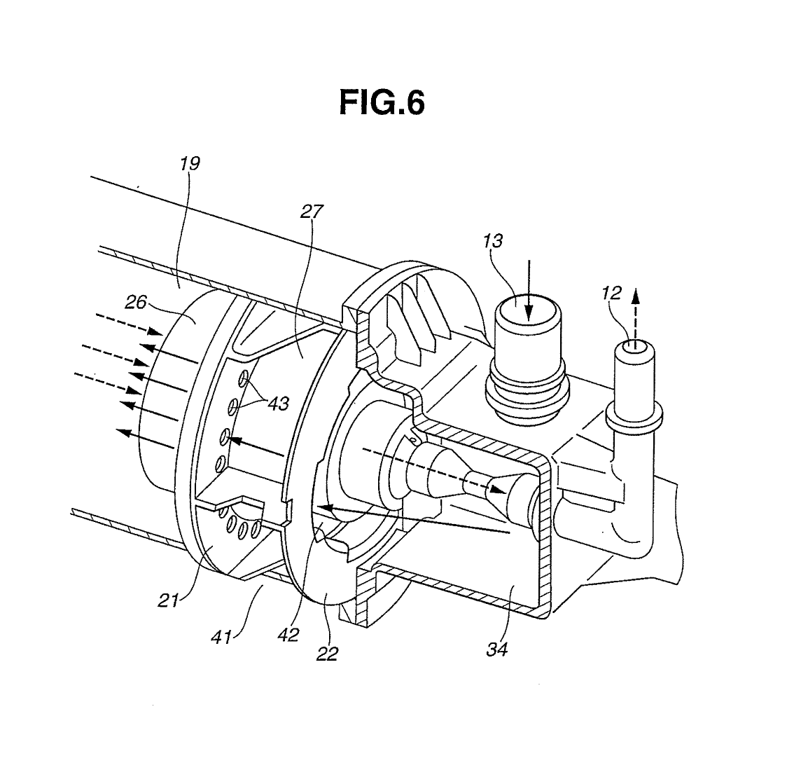

With the arrangement as discussed above, a gas containing fuel vapors generated within the fuel tank (referred to as a charged gas in this specification) flows from the charge port 13 into the charged gas chamber 34 as indicated by solid arrows in FIGS. 5 and 6 and then flows into the diffusion chamber 41 through the apertures 42 serving as the auxiliary throttling parts, thereby being guided into the adsorbent chamber 19 through a plurality of orifices 43. A gas incorporated through the charge port 13 from the radial direction with respect to the center axis L of the main body 3 expands in the charged gas chamber 34, contracts at the apertures 42, expands again in the diffusion chamber 41, contracts by the orifices 43 and then expands in the adsorbent chamber 19. As a result of such a repetition of cycles of expansion and contraction, the speed vector of the gas flow at the charge port 13 in the radial direction disappears, with which the gas becomes capable of flowing into the adsorbent chamber 19 with no bias through the apertures 42. In particular, a plurality of orifices 43 are concentrically arranged and adjacent to the first cylindrical section 26; therefore in the adsorbent chamber 19 the charged gas is delivered from the radially innermost location (which location is disposed radially outside the center portion defined within the first cylindrical section 26) along the outer peripheral surface of the first cylindrical section 26, with a flow which is individually thin and totally cylindrical. Accordingly, the charged gas is introduced evenly in circumferential direction and charging is to progress in such a manner as to expand in radial direction from each of the orifices 43 arranged in the vicinity of the center portion of the first cylindrical section 26. As a result, the distribution of the adsorption quantity gets even in the circumferential direction, and therefore charging of fuel vapors is achieved with full use of the adsorbing material 20 housed in the adsorbent chamber 19.

On the other hand, at the time of purging, a purged gas (a mixture of air incorporated through the drain port 7 and a fuel component) flows in a manner as to concentrate in the first cylindrical section 26 that constitutes the center of the main body 3, as indicated in FIGS. 5 and 6 by broken line arrows. Then, the gas is to flow into the purge port 12 through the third cylindrical section 28, the fourth cylindrical section 35 and the connecting pipe 37. Thus the gas is adapted to flow linearly along the center axis L of the main body 3 and therefore the adsorbing material 20 housed in the adsorbent chamber 19 can evenly develop purging with no bias in the circumferential direction.

Thus, both of charging and purging can progress evenly in the circumferential direction with no bias so that the adsorbing material is entirely fully used. The adsorption ability of the canister is greatly obtained and additionally a leakage of fuel component due to an insufficient purging (the so-called bleed) is well suppressed.

Although the invention has been described above by reference to certain embodiments and examples of the invention, the invention is not limited to the embodiments and examples described above. Modifications and variations of the embodiments and examples described above will occur to those skilled in the art, in light of the above teachings. Although the above example shows a construction where the charge port is provided to communicate with the circularly arranged orifices while the purge port is provided to communicate with the inside of the first cylindrical section disposed on the center of the canister, the present invention can also allow another construction where the purge port is provided to communicate with the circularly arranged orifices while the charge port is provided to communicate with the inside of the first cylindrical section disposed on the center of the canister.

Further, although in the above-mentioned example a casing is constructed to have a single line shape extending from one end to the other end (for example, from the side of the charge port and the purge port to the side of the drain port), the present invention is also applicable to a casing the midsection of which is bent like a letter U. In this case, the first end portion of the casing at which the charge port and the purge port are disposed and the second end portion of the casing at which the drain port is disposed are provided adjacent to each other.

The entire contents of Japanese Patent Application P2013-114897 (filed May 31, 2013) are incorporated herein by reference. The scope of the invention is defined with reference to the following claims.

What is claimed is:

1. A canister comprising:
a cylindrical casing charged with an adsorbing material therein and having at one end and the other end of the longitudinal direction of the casing a first end portion and a second end portion, respectively;
a charge port and a purge port both of which are disposed at the first end portion of the casing;
a drain port disposed at the second end portion of the casing;
an annularly shaped flange section disposed at the first end portion of the casing to define an outer peripheral part of one end of an adsorbent chamber;
a first cylindrical section projected from the inner periphery of the flange section toward the side of the adsorbent chamber and concentric with the casing; and
a second cylindrical section extending from the inner periphery of the flange section in the opposite direction of the first cylindrical section and concentric with the casing,
wherein a space defined inside the first cylindrical section at the center of the casing communicates with a first port comprising either one of the charge port and the purge port, while a diffusion chamber circularly defined between the second cylindrical section and the casing communicates with a second port comprising the other one of the charge port and the purge port,
wherein the flange section has two or more orifices for communicating the adsorbent chamber and the diffusion chamber with each other, the orifices being located adjacent to the first cylindrical section and arranged concentrically about the first cylindrical section.

2. A canister as claimed in claim 1, further comprising a screen member, wherein the first cylindrical section and the second cylindrical section are identical in outer diameter to each other and the screen member is disposed at the interface therebetween to define an end of the center of the adsorbent chamber.

3. A canister as claimed in claim 1, further comprising a third cylindrical section located inside an inner periphery of the second cylindrical section and smaller than the first cylindrical section in diameter, wherein the space defined inside the first cylindrical section communicates with the first port through a space defined inside the third cylindrical section.

4. A canister as claimed in claim 1, further comprising a second diffusion chamber located between the diffusion chamber and the second port and adjacent to the diffusion chamber in the longitudinal direction of the casing, wherein the second diffusion chamber and the diffusion chamber are communicated with each other through two or more auxiliary throttling parts formed adjacent to an outer peripheral surface of the second cylindrical section.

5. A canister as claimed in claim 1, wherein the orifices are arranged concentrically about the first cylindrical section at fixed intervals.

6. A canister as claimed in claim 1, wherein the first port is the purge port while the second port is the charge port.
